(19) United States
(12) Patent Application Publication
(10) Pub. No.: US 2013/0004110 A1
(43) Pub. Date: Jan. 3, 2013

(54) BEARING RING

(75) Inventors: Wolfram Kruhoeffer, Aurachtal (DE); Tobias Mederer, Schwanstetten (DE); Oliver Graf-Goller, Heroldsberg (DE)

(73) Assignee: SCHAEFFLER TECHNOLOGIES AG & CO. KG, Herzogenaurach (DE)

(21) Appl. No.: 13/634,994

(22) PCT Filed: Feb. 3, 2011
(86) PCT No.: PCT/EP11/51514

§ 371 Date: Sep. 14, 2012

(30) Foreign Application Priority Data
Mar. 24, 2010 (DE) 10 2010 012 476.1

(51) Int. Cl. F16C 33/60

(52) U.S. Cl. 384/502

(57) ABSTRACT

A bearing ring includes a ring element having at least two grooves which extend from one axial side to the other axial side of the ring element and form predetermined breaking lines for cracking the ring element. The ring element is in the form of a sleeve produced by deep-drawing, wherein the grooves are also machined in during the deep-drawing of the sleeve.

### FIELD OF THE INVENTION

The invention refers to a bearing ring, comprising a ring element, which has at least two grooves which extend from one axial side to the other axial side of the ring element and form predetermined break lines for breaking open (cracking open) the ring element.

### BACKGROUND OF THE INVENTION

Such a bearing ring is known from EP 0 016 529 B1. The grooves which are depicted and described there have an angular or zigzag shape so that the bearing halves which are available after the cracking open are adjusted in relation to each other during assembly and tensioning. Furthermore, the basic material consists of a soft material which is carburized on the inner surface and outer surface and is also carburized throughout in the region of the groove base in order to create a hard material in the region of the cracking zone.

The production of such a bearing ring is very complex and cost-intensive, however, especially as the particular groove characteristic is difficult to produce. Furthermore, a costly remachining of the inner surfaces is required after the splitting of the ring since protrusions and deformations, as a result of the cracking open, are created at the break zone on the inner surface of the ring element. Finish-machining, for example finish-grinding of the running track and/or honing thereof, is not sufficient either since during assembly of the bearing halves the rough surfaces—created by the cracking open—at the break point do not always match each other and therefore unwanted deformations are subsequently additionally created in the inner region of the bearing ring.

### OBJECT OF THE INVENTION

It is therefore the object of the invention to improve upon the disadvantages of the bearing ring according to the prior art, to simplify this bearing ring and to develop it more cost-effectively. Furthermore, it is to be ensured that at the transition region of the bearing shells, which are assembled after the splitting, damaging deformations which protrude into the bearing inner surface are not created.

### DESCRIPTION OF THE INVENTION

According to the invention, this object is achieved in the case of a bearing ring according to the preamble of claim 1 in such a way that the ring element is designed as a sleeve which is produced by deep drawing, and that the grooves are also incorporated during the deep drawing of the sleeve. Created as a result is a bearing ring which can be cost-effectively and simply produced since the complete forming is carried out in one working operation.

It is an advantageous embodiment of the invention if the ring element has only two essentially oppositely disposed grooves. In this case, the grooves are formed exclusively on the inner side of the sleeve as notches which are tapered to a point in the direction towards the sleeve core. As a result, it is ensured that a defined break line is created, in which break line there is no risk to the bearing inner surface as a result of projecting material points and the like. It would also be conceivable, however, to form the ring element with three or more uniformly circumferentially distributed grooves.

As a further embodiment of the invention, it is furthermore proposed that the grooves are formed as notches or running track reliefs and provided on the inner surface of the sleeve. As a result, it is ensured that even after the separating and subsequent joining together no material finds its ways into the running track of the bearing ring. Into the running track reliefs—the cross-sectional profile of which is designed in the shape of an arc—a notch can then additionally be introduced, preferably on the base of the running track reliefs, as a result of which the break lines are clearly defined.

In order to achieve a particularly favorable transition between the notches or running track reliefs on the inner surface of the bearing ring, it is furthermore proposed that the transition region between the notches or running track reliefs, which are introduced on the inner surface, and the bearing surface is defined by a logarithmic characteristic so that a favorable rolling region is also ensured when using rolling bodies inside the bearing ring.

It is advantageous, moreover, if provision is additionally made on the outer surface of the ring element for notches which lie opposite the notches or running track reliefs of the inner side and which are tapered to a point in the direction towards the sleeve core. As a result, a favorable parting line is created after the cracking open without influencing the specific design of the inner transition.

### BRIEF DESCRIPTION OF THE DRAWINGS

For further explanation of the invention, reference is made to the drawings in which a plurality of exemplary embodiments of the invention are represented in a simplified manner. In this case, in the drawings:

FIG. 1 shows a perspective view of an unsplit sleeve after the deep drawing;

FIG. 2 shows a detail of the sleeve on an enlarged scale with a notch on the inner surface;

FIG. 3 shows a detail of the sleeve on an enlarged scale with a notch on the inner surface and an additional notch on the outer surface;

FIG. 4 shows an embodiment according to FIG. 3 with an outer notch which has a round transition to the outer surface of the sleeve;

FIG. 5 shows a view corresponding to FIG. 3 but in which instead of a notch on the inner side a running track relief in the form of a groove with a round groove base is provided;

FIG. 6 shows a view similar to FIG. 5 with an additional notch in the running track relief.

### DETAILED DESCRIPTION OF THE DRAWINGS

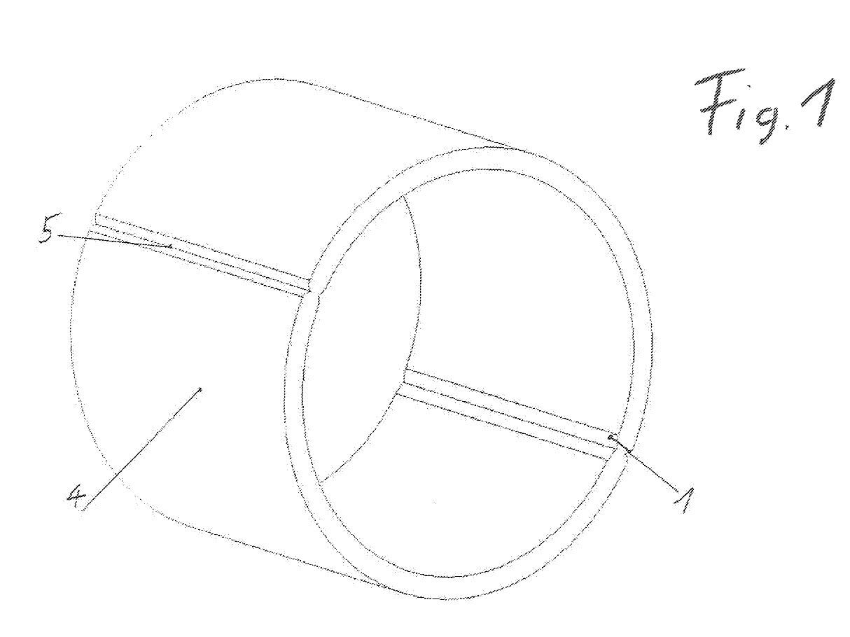

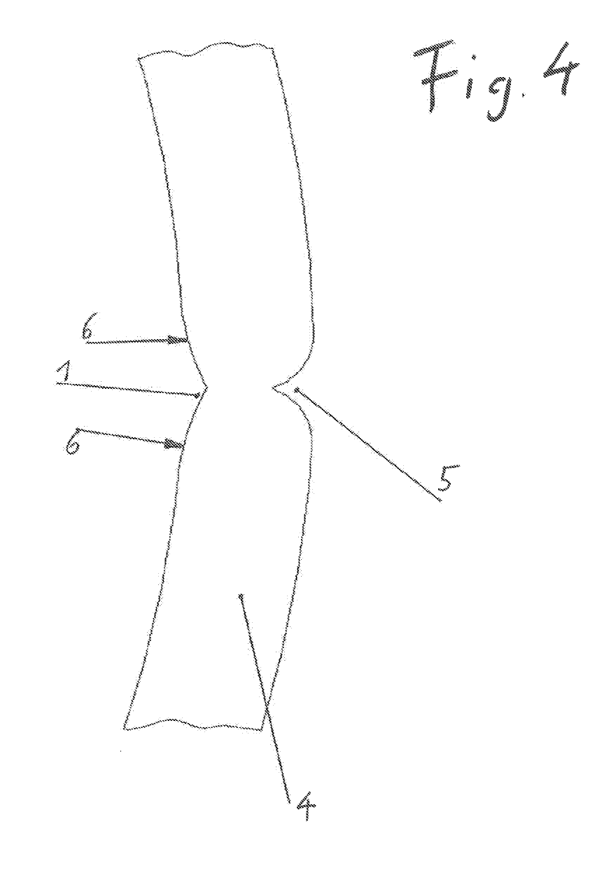

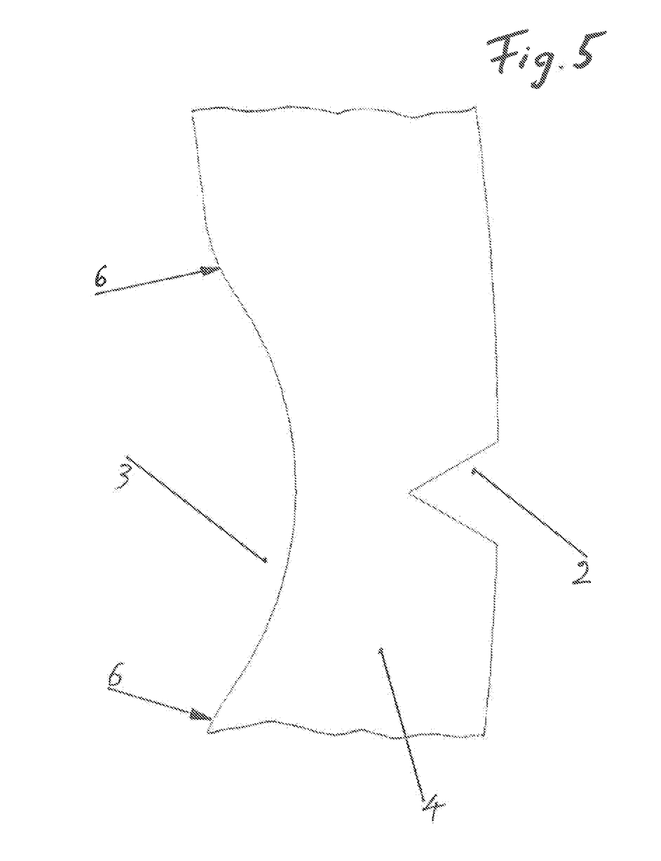

A sleeve, in as far as being shown in detail, is designated 4 in FIGS. 1 and 5 and has an inner notch 1 and an outer notch 5 on opposite sides, wherein the notches lie opposite each other in each case. The notches are formed according to FIG. 4 which shows a detail of the sleeve 4 on an enlarged scale. The outer notch 5 tapers to a point in the middle in the direction of the sleeve core and has rounded transitions to the outer surface of the sleeve 4.

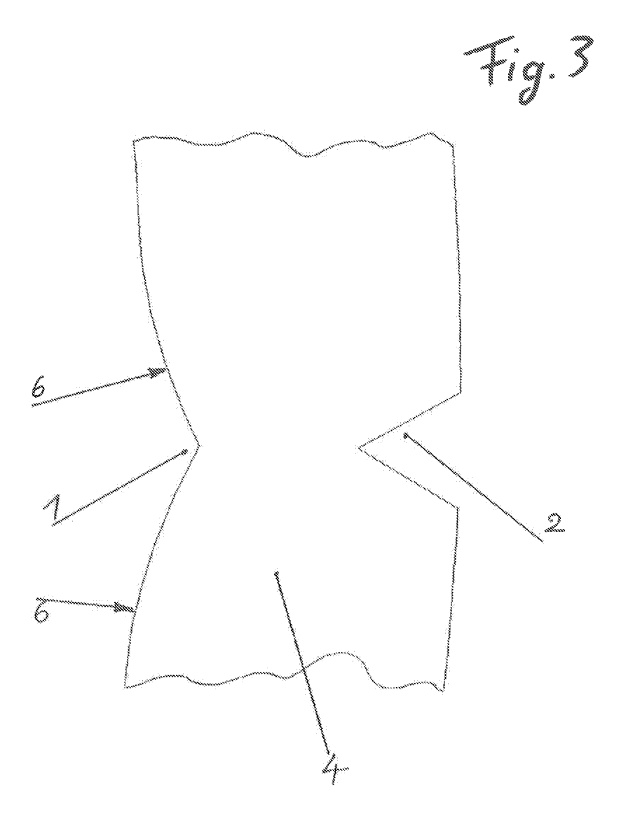

The sleeve 4 in FIG. 3 differs from FIGS. 1 and 4 by the fact that the modified outer notch, which is designated 2, has angular transitions to the outer surface of the sleeve 4.

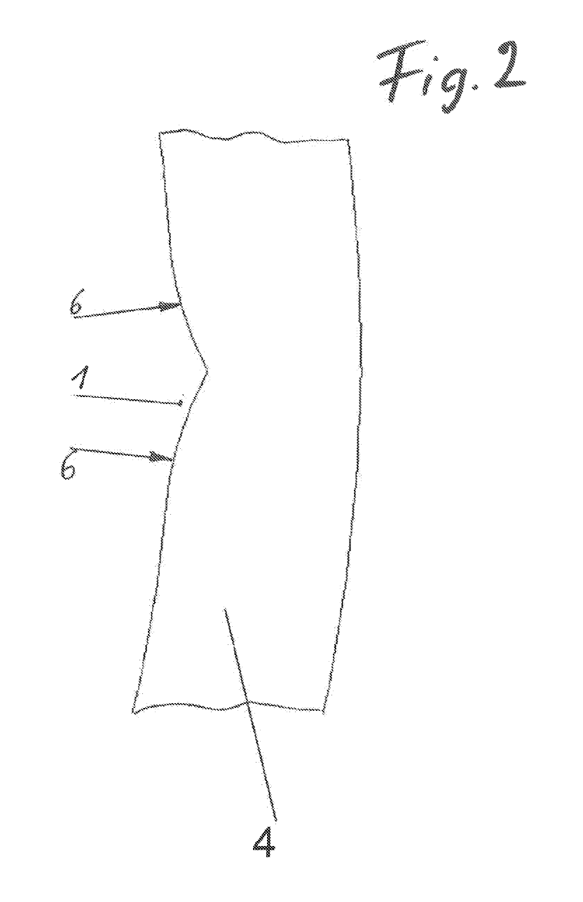

As shown in FIG. 2, it is not absolutely necessary that notches 2 or 5 are provided on the outer surface. It suffices if inner notches 1 are introduced on the inner surface and if the sleeve thickness is selected so that cracking open is possible.

The modified outer notch 2 according to FIG. 5 corresponds to the embodiment according to FIG. 3. By way of variance, however, provision is made on the opposite inner side for a running track relief 3 which ensures that, even after the cracking open, there is no influence upon the inner surface of the bearing ring. The transitions 6 from the running track reliefs 3 to the inner surface of the sleeve 4 and/or from the inner notches 1 to the inner surface of the sleeve 4 are advantageously designed as transition regions 6 which have a logarithmic characteristic in order to ensure an optimum transition.

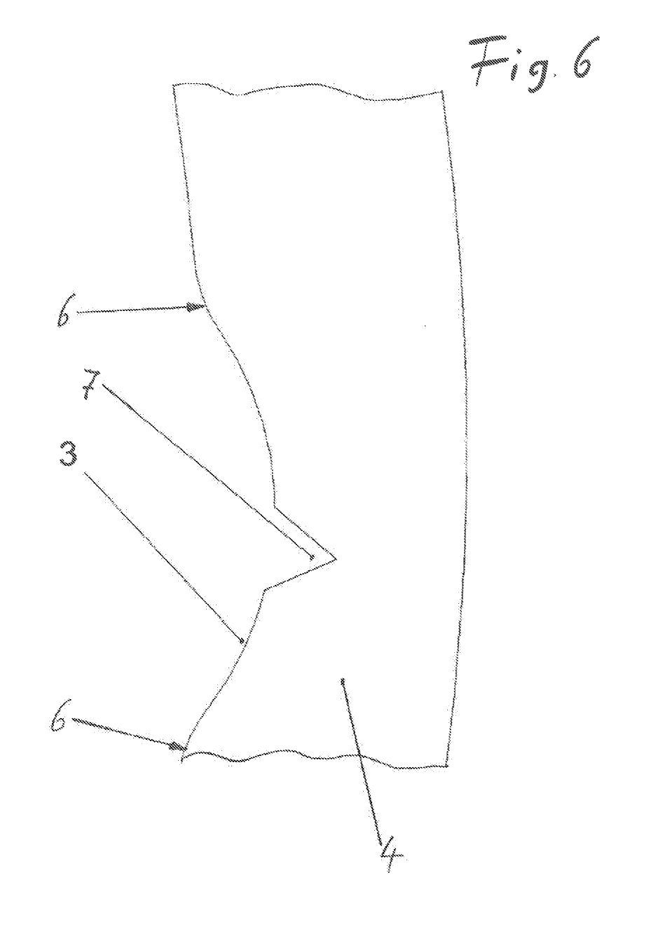

In FIG. 6, which resembles FIG. 5, an additional notch 7 is incorporated in the base of the running track relief 3, as a result of which the characteristic of the break line is clearly predetermined. The notch 2 on the outer surface, as in FIG. 5, can be dispensed with in this case.

### LIST OF DESIGNATIONS

1 Inner notches
2 Modified outer notches
3 Running track reliefs
4 Sleeve
5 Outer notches
6 Transition regions

1.-7. (canceled)

8. A bearing ring, comprising a ring element having first and second axial sides, and at least two grooves which extend from the first axial side to the second axial side of the ring element and form predetermined break lines for breaking open the ring element, the ring element being a sleeve produced by deep drawing, and the at least two grooves are also incorporated into the sleeve during the deep drawing of the sleeve.

9. The bearing ring as claimed in claim 8, wherein the at least two grooves include two essentially oppositely disposed grooves.

10. The bearing ring as claimed in claim 9, wherein the grooves are formed exclusively on an inner surface of the sleeve as notches which are tapered to a point in the direction towards the sleeve core.

11. The bearing ring as claimed in claim 8, wherein the grooves are formed as notches or running track reliefs on an inner surface of the sleeve.

12. The bearing ring as claimed in claim 11, wherein the grooves are formed as running track reliefs and the ring element further comprises additional notches incorporated in the running track reliefs.

13. The bearing ring as claimed in claim 11, wherein transition regions between the notches or running track reliefs, which are arranged on the inner surface, and a bearing surface are defined by a logarithmic characteristic.

14. The bearing ring as claimed in claim 11, further comprising notches on an outer surface which lie opposite the notches or running track reliefs of the inner surface and which are tapered to a point in the direction towards the sleeve core.
